(19) United States
(12) Patent Application Publication
(10) Pub. No.: US 2026/0099228 A1
(43) Pub. Date: Apr. 9, 2026

(54) ELECTROSTATIC INPUT APPARATUS

(71) Applicant: ALPS ALPINE CO., LTD., Tokyo (JP)

(72) Inventor: Masaru ONOSE, Unterschleissheim (DE)

(21) Appl. No.: 19/418,130

(22) Filed: Dec. 12, 2025

Related U.S. Application Data
(63) Continuation of application No. PCT/JP2024/008114, filed on Mar. 4, 2024.

(30) Foreign Application Priority Data
Jun. 21, 2023 (JP) 2023-101973

(51) Int. Cl. G06F 3/041; G06F 3/044

(52) U.S. Cl. CPC G06F 3/04184; G06F 3/044; G06F 2203/04101; G06F 2203/04107

(57) ABSTRACT

An electrostatic input apparatus includes a sensor electrode configured to perform input detection; a processor; and a memory that includes instructions, which when executed, cause the processor to execute performing switching control between a regular mode and a low power consumption mode, and determining presence/absence of an operation input based on a difference value obtained by subtracting a reference value from an output value of the sensor electrode; updating the reference value based on the output value in an intermittent operation in the low power consumption mode; and in a first determination of first determining the presence/absence of the operation input after switching from the low power consumption mode to the regular mode, determining the presence/absence by using the output value first acquired in the first determination of the presence/absence of the operation input and the reference value last updated in the low power consumption mode.

### CROSS-REFERENCE TO RELATED APPLICATION

The present application is a continuation application of International Application No. PCT/JP2024/008114 filed on March 4, 2024, which is based on and claims priority to Japanese Patent Application No. 2023-101973 filed on June 21, 2023. The contents of these applications are incorporated herein by reference in their entirety.

### BACKGROUND OF THE INVENTION

### 1. Field of the Invention

The present disclosure relates to an electrostatic input apparatus.

### 2. Description of the Related Art

Conventionally, there has been a touch panel controller which, in a first mode for enabling display of a display panel, performs a normal scan for detecting all detection points on a touch detection surface of the touch panel. In a second mode for disabling display of a display panel by a display driver, the touch panel controller performs a low power scan for detecting remaining lines obtained by subtracting detection points by a plurality of lines every other line on a touch detection surface of the touch panel. The touch panel controller performs the low power scan intermittently during a rest period in a second mode. The touch panel controller further has a third mode for disabling touch detection for the touch panel and disabling display of the display panel by the display driver (for example, see Patent Document 1).

Patent Document 1: Japanese Unexamined Patent Application Publication No. 2015-170139

### SUMMARY OF THE INVENTION

The electrostatic input apparatus according to an embodiment of the present disclosure includes a sensor electrode configured to perform input detection; a processor; and a memory that includes instructions, which when executed, cause the processor to execute performing switching control between a regular mode and a low power consumption mode, and determining presence/absence of an operation input based on a difference value obtained by subtracting a reference value from an output value of the sensor electrode; updating the reference value based on the output value in an intermittent operation in the low power consumption mode; and in a first determination of first determining the presence/absence of the operation input after switching from the low power consumption mode to the regular mode, determining the presence/absence by using the output value first acquired in the first determination of the presence/absence of the operation input and the reference value last updated in the low power consumption mode.

### BRIEF DESCRIPTION OF DRAWINGS

FIG. 1 is a diagram illustrating an example of the configuration of an electrostatic input apparatus according to an embodiment;

FIG. 2 is a diagram illustrating an example of the block configuration of an electrostatic input apparatus according to an embodiment;

FIG. 3A is a diagram illustrating an example of operation of an electrostatic input apparatus according to an embodiment;

FIG. 3B is a diagram illustrating an example of operation of an electrostatic input apparatus according to an embodiment;

FIG. 3C is a diagram illustrating an example of operation of an electrostatic input apparatus according to an embodiment;

FIG. 3D is a diagram illustrating an example of operation of a comparative electrostatic input apparatus;

FIG. 4 is a diagram for explaining an example of adjustment of a predetermined time interval at which the electrostatic input apparatus of the embodiment performs intermittent operation; and

FIG. 5 is a flowchart illustrating an example of processing executed by the control unit of the electrostatic input apparatus of the embodiment.

### DETAILED DESCRIPTION OF THE PREFERRED EMBODIMENTS

In an electrostatic input apparatus such as a touch panel, a reference value corresponding to a noise level or the like may be subtracted from an output value of a sensor electrode when detecting a position where an operation input is performed. Because the noise level or the like changes with time due to changes in the surrounding environment or the like, the reference value is updated with the passage of time.

Although the conventional touch panel controller does not use a reference value, in the conventional touch panel controller, if a reference value is acquired after returning from the third mode to the second mode, the detection of the position of the operation input is delayed. Similarly, in the conventional touch panel controller, if a reference value is acquired after returning from the second mode to the first mode, the detection of the position of the operation input is delayed.

An object is to provide an electrostatic input apparatus capable of quickly determining the position of the operation input when returning from the low power consumption mode to the regular mode.

Hereinafter, an embodiment to which the electrostatic input apparatus of the present disclosure is applied will be described. Hereinafter, the same elements are denoted by the same reference numerals, and redundant descriptions may be omitted.

Hereinafter, the XYZ coordinate system will be defined and described. The direction parallel to the X axis (X direction), the direction parallel to the Y axis (Y direction), and the direction parallel to the Z axis (Z direction) are mutually orthogonal. The XYZ coordinate system is an example of an orthogonal coordinate system. Viewing in the XY plane is referred to as a plan view. In the following, the length, size, thickness, and the like of each portion are sometimes exaggerated in order to make the configuration easier to understand. Further, the words such as parallel, right angle, orthogonal, horizontal, perpendicular, vertical, and the like are allowed to deviate to a degree that does not impair the effect of the embodiment.

### Embodiment

### Configuration of electrostatic input apparatus 100

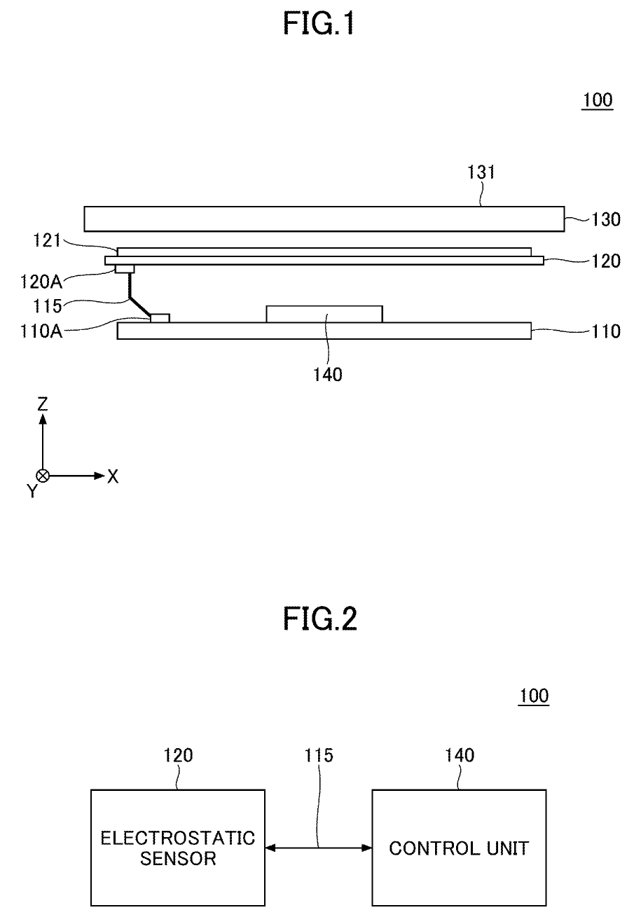

FIG. 1 is a diagram illustrating an example of the configuration of an electrostatic input apparatus 100 of the embodiment. The electrostatic input apparatus 100 includes a substrate 110, an electrostatic sensor 120, a top panel 130, and a control unit 140. FIG. 2 is a diagram illustrating an example of the block configuration of the electrostatic input apparatus 100. FIG. 2 illustrates the electrostatic sensor 120 and the control unit 140.

The electrostatic input apparatus 100 may be an input device or the like arranged on a center console, a door panel, a steering wheel, or the like of a vehicle. The electrostatic input apparatus 100 may be, for example, an input device arranged in a store, a facility, or the like and used by an unspecified number of users, a tablet-type input device, or an input unit of an ATM (Automatic Teller Machine). The electrostatic input apparatus 100 may be a tablet computer, a smartphone, a game machine, or the like for personal use. In the following, as an example, a configuration in which the electrostatic input apparatus 100 is mounted in a vehicle will be described.

### Substrate 110

The substrate 110 is a wiring substrate, and as an example, a printed wiring substrate of a standard such as FR-4 (Flame Retardant type 4) may be used. As an example, a control unit 140 is mounted on a surface of the substrate 110 in the +Z direction. The control unit 140 is connected to a terminal 110A via the wiring of the substrate 110. The terminal 110A is connected to the terminal 120A of the electrostatic sensor 120 via the signal line 115. Therefore, as illustrated in FIG. 2, the electrostatic sensor 120 and the control unit 140 can transmit and receive signals or the like via the signal line 115.

### Electrostatic sensor 120

The electrostatic sensor 120 is arranged between the substrate 110 and the top panel 130 in the Z direction. The electrostatic sensor 120 has, as an example, a sensor electrode 121 for input detection on the +Z direction side. The sensor electrode 121 may have, as an example, a plurality of electrodes extending in the X direction and a plurality of electrodes extending in the Y direction. The sensor electrode 121 may have a plurality of electrodes arranged in the X direction and/or the Y direction. The sensor electrode 121 may have only one electrode.

The electrostatic sensor 120 outputs to the control unit 140 a digital output value AD obtained by digitally converting an output value of the sensor electrode 121 representing an electrostatic capacitance between the sensor electrode 121 and an object such as an operator's hand or fingertip. Hereinafter, as an example, the object is a fingertip. The digital output value AD is used when the control unit 140 calculates the XY coordinates of the fingertip on the operation surface 131 of the top panel 130 and the distance between the operation surface 131 and the fingertip in the Z direction.

The electrostatic input apparatus 100 may have a display such as a liquid crystal or an organic electroluminescence (EL) display. In this case, as an example, the display may be arranged between the electrostatic sensor 120 and the substrate 110, and the electrostatic sensor 120 and the top panel 130 may be transparent. Transparent means that the display is transparent to visible light and an image of the display can be seen from the operation surface 131.

### Top panel 130

The top panel 130 is a panel arranged in an operation unit of the electrostatic input apparatus 100 and has an operation surface 131. The top panel 130 is, for example, made of resin or glass. The operation surface 131 of the top panel 130 is, for example, exposed to the interior of a vehicle.

### Control unit 140

The control unit 140 is implemented by a computer including a CPU (Central Processing Unit), a RAM (Random Access Memory), a ROM (Read Only Memory), an input/output interface, an internal bus, and the like.

The control unit 140 controls the overall electrostatic input apparatus 100 and performs various kinds of control. As an example, the control unit 140 performs switching control of the mode (regular mode, temporary activation mode, and standby mode) of the electrostatic input apparatus 100 and determines the presence/absence of an operation input. The temporary activation mode and the standby mode are examples of low power consumption modes. The standby mode is synonymous with a sleep mode. As an example of determining the presence or absence of an operation input, the control unit 140 calculates the XY coordinates of the fingertip on the operation surface 131 of the top panel 130 and the distance between the operation surface 131 and the fingertip in the Z direction based on the digital output value AD output from the electrostatic sensor 120. The control unit 140 may be configured to calculate only the XY coordinates of the fingertip on the operation surface 131 of the top panel 130 and not calculate the distance between the operation surface 131 and the fingertip in the Z direction based on the digital output value AD.

### Reference value BASE

The control unit 140 determines the presence or absence of an operation input based on a difference value ΔAD obtained by subtracting the reference value BASE from the digital output value AD. The reason for subtracting the reference value BASE from the digital output value AD is to reduce the influence of noise or the like. The difference value ΔAD is a variation of the digital output value AD, which is the output of the electrostatic sensor 120, with respect to the reference value BASE, and is represented by a count value as an example.

The control unit 140 acquires the digital output value AD occurring when no operation input is performed as the reference value BASE. When the electrostatic input apparatus 100 is in the standby mode, the control unit 140 updates the reference value BASE by intermittently switching to the temporary activation mode and scanning the digital output value AD. In this way, the electrostatic input apparatus 100 updates the reference value BASE by intermittent operation. When the reference value BASE is updated, the control unit 140 returns to the standby mode from the temporary activation mode. During the standby mode, the mode is intermittently switched to the temporary activation mode, and the time of the temporary activation mode for 1 instance is approximately several hundred milliseconds as an example, and the mode returns to the standby mode when the temporary activation mode ends. Intermittently switching to the temporary activation mode means repeatedly switching to the temporary activation mode at predetermined time intervals during the standby mode.

The intermittent operation is an operation obtained by thinning the number of operations in which the control unit 140 scans the digital output value AD in the regular mode. In the regular mode, the control unit 140 repeatedly and continuously scans the digital output value AD in a predetermined cycle. The number of instances of scanning the digital output value AD in the intermittent operation is the number of instances obtained by thinning the number of operations of scanning in the regular mode.

### Plural types of operation inputs

The control unit 140 has a plurality of predetermined thresholds corresponding to the distance in the Z direction between the operation surface 131 and the fingertip in order to determine the distance between the operation surface 131 and the fingertip in a stepwise manner. The plurality of predetermined thresholds are, for example, a plurality of thresholds for determining the distance between the operation surface 131 and the fingertip, and are, for example, a plurality of thresholds for determining 4 types of operation inputs: proximity operation, selection operation, determination operation, and contact operation. The plurality of predetermined thresholds may be a plurality of thresholds for determining any 2 or more operations among the 4 types of operation inputs: proximity operation, selection operation, determination operation, and contact operation.

The proximity operation is an operation in which the fingertip is brought closer to the operation surface 131 without touching the operation surface 131, and is an operation input in which the distance between the fingertip and the operation surface 131 is the greatest among the 4 operation inputs.

The selection operation is an operation in which the fingertip is brought closer to the operation surface 131 without touching the operation surface 131 from a state in which the proximity operation has been performed to select a specific operation unit of the operation surface 131. When the electrostatic input apparatus 100 includes a display, the specific operation unit may be a button or the like displayed on the display by a GUI (Graphic User Interface).

The determining operation is an operation for determining an operation input to a selected specific operation unit by bringing a fingertip closer to the operation surface 131 without touching the operation surface 131 from a state in which a selection operation has been performed. The determining operation is to perform an operation input in a non-contact manner, and to operate the electrostatic input apparatus 100 in a non-contact manner without touching the operation surface 131 with a fingertip. The operation input performed by the selection operation and the determining operation in a non-contact manner may be referred to as a hover input or a touchless input.

The contact operation is an operation for determining an operation input to a selected specific operation unit by bringing a fingertip closer to the operation surface 131 and touching the operation surface 131 from a state in which a selection operation has been performed. The contact operation may be referred to as touch input.

### Regular mode, temporary activation mode, and standby mode

As an example, the electrostatic input apparatus 100 has 3 modes: a regular mode, a temporary activation mode, and a standby mode. Among these modes, the temporary activation mode and the standby mode are low power consumption modes for reducing power consumption of the electrostatic input apparatus 100. Here, as an example, a configuration in which the low power consumption mode is divided into two modes of the temporary activation mode and the standby mode will be described, but the low power consumption mode may be a single mode.

The regular mode is a state in which the electrostatic input apparatus 100 can perform all operations, and a mode in which the power consumption of the electrostatic input apparatus 100 is not particularly reduced. In the regular mode, the control unit 140 can perform all types of control.

In the standby mode, the electrostatic input apparatus 100 is a mode in which the power consumption is reduced. In the standby mode, the operation of the electrostatic input apparatus 100 is restricted. For example, the operation of the control unit 140 is restricted, and the position of the operation input (the position in the XY plane and the position in the Z direction) is not calculated. If the electrostatic input apparatus 100 includes a display, the display of the display is turned off in the standby mode.

The control unit 140 sets the mode to the standby mode when, for example, the ignition or power switch of the vehicle in which the electrostatic input apparatus 100 is mounted is turned off. The control unit 140 switches the mode from the standby mode to the regular mode when, for example, the ignition or power switch of the vehicle in which the electrostatic input apparatus 100 is mounted is turned on.

The temporary activation mode is an activation mode that the mode of the electrostatic input apparatus 100 is temporarily switched to from the standby mode, in order to update the reference value BASE by intermittent operation at predetermined time intervals when the electrostatic input apparatus 100 is in the standby mode. The predetermined time may be a fixed time, and may be shortened or extended according to the influence of, for example, disturbance. Disturbance will be described later.

In the temporary activation mode, the control unit 140 can acquire the digital output value AD, calculate (update) the reference value BASE, and calculate the difference value ΔAD, but other operations are restricted as in the standby mode. For example, in the temporary activation mode, the control unit 140 does not calculate the position of the operation input (the position in the XY plane and the position in the Z direction). If the electrostatic input apparatus 100 includes a display, the display is held in an off state. The temporary activation mode is an example of a low power consumption mode in which power consumption is lower than that of the regular mode. The control unit 140 switches from the temporary activation mode to the regular mode when, for example, an ignition or a power switch of a vehicle in which the electrostatic input apparatus 100 is mounted is turned on.

The electrostatic input apparatus 100 is intermittently switched to a temporary activation mode during the standby mode in order to quickly determine the position of the operation input when the standby mode or the temporary activation mode is returned to the regular mode, and the control unit 140 updates the reference value BASE based on the digital output value AD. In this way, the electrostatic input apparatus 100 updates the reference value BASE by intermittent operation.

Further, the control unit 140 determines the presence or absence of the first operation input after switching from the standby mode or the temporary activation mode to the regular mode by using the digital output value AD first acquired in the determination of the presence or absence of the first operation input and the reference value BASE last updated in the temporary activation mode. Details of this will be described later.

### Example of operation of electrostatic input apparatus 100

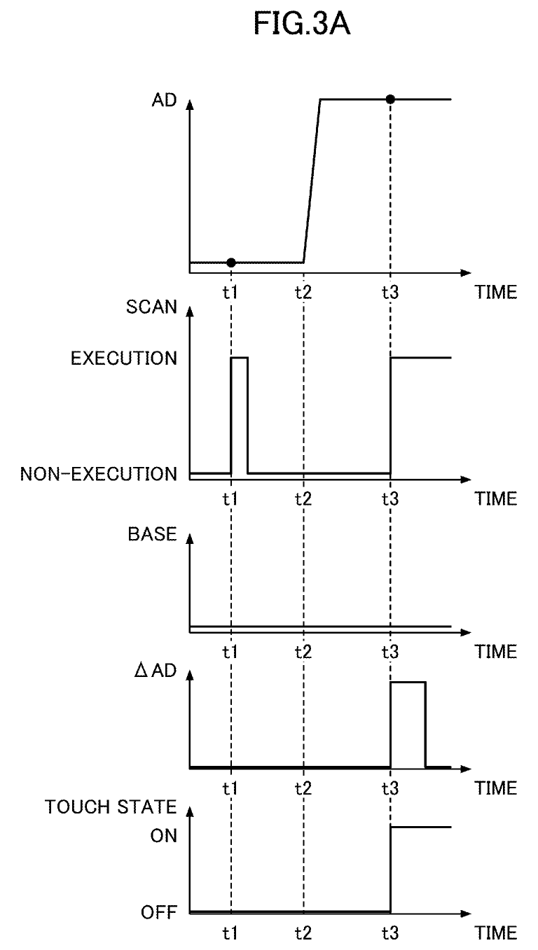

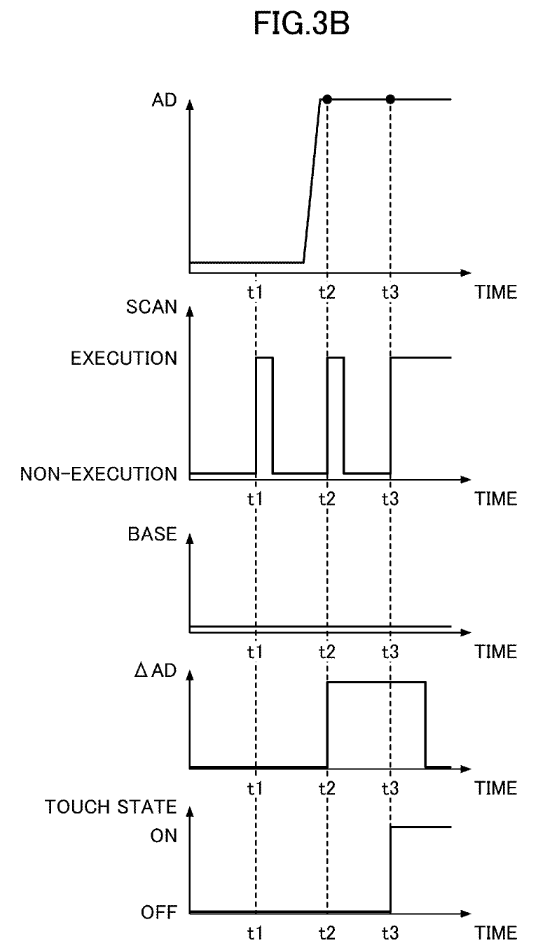

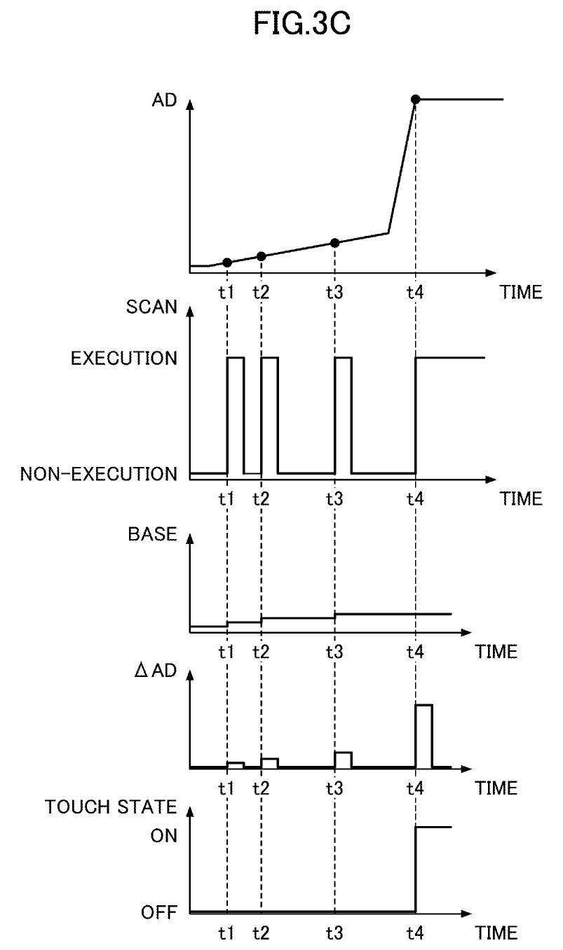

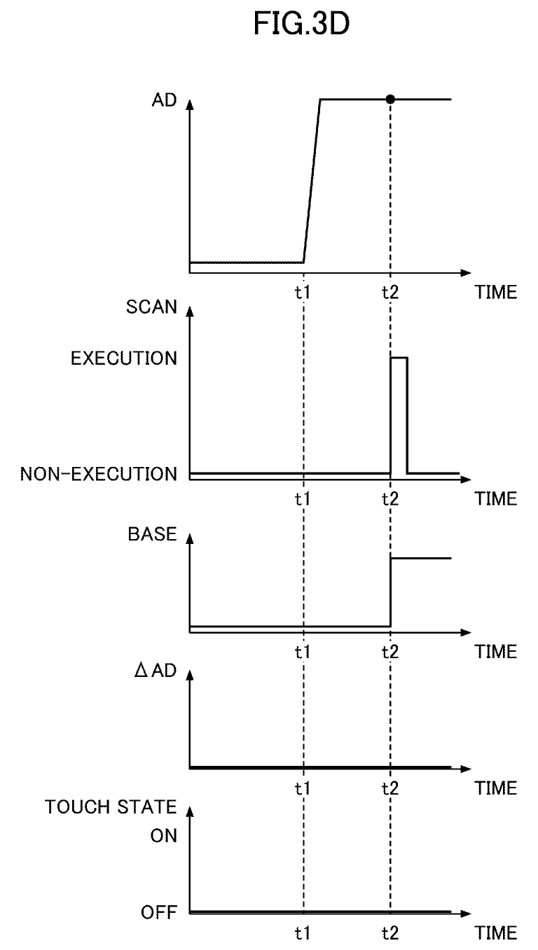

FIGS. 3A to 3C are diagrams illustrating an example of the operation of the electrostatic input apparatus 100. In FIGS. 3A to 3C, the horizontal axis represents time. The 5 vertical axes represent, in order from the top, the digital output value AD, scan, reference value BASE, difference value ΔAD, and touch state. Scan is an operation in which the control unit 140 acquires the digital output value AD from the electrostatic sensor 120, and is represented by 2 levels of execution (scan is performed) and non-execution (scan is not performed).

The touch state is represented by ON or OFF. When the touch state is ON, it is a result of the determination of the presence/absence of the contact operation by the control unit 140, and it indicates that the contact operation is present. When the touch state is OFF, it is a result of the determination of the presence/absence of the contact operation by the control unit 140, and it indicates that the contact operation is not present. Here, in order to simplify the description, it is assumed that the control unit 140 determines only the presence/absence of the contact operation, and does not determine the presence/absence of the proximity operation, the selection operation, and the determination operation.

In FIGS. 3A to 3C, it is assumed that the electrostatic input apparatus 100 is set to the standby mode in the initial state before time t1.

### Operation of FIG. 3A

In FIG. 3A, at time t1, the control unit 140 acquires the digital output value AD by scanning in the intermittent operation and updates the reference value BASE. That is, the mode is intermittently switched to the temporary activation mode during the standby mode to acquire the digital output value AD, update the reference value BASE, and calculate the difference value ΔAD. The acquired digital output value AD is indicated by a black circle (●). The digital output value AD is very small, and the reference value BASE is also very small. The control unit 140 calculates the difference value ΔAD, but because both the digital output value AD and the reference value BASE are the same value, there is no difference value ΔAD. Therefore, there is no change from the value of the reference value BASE before the time t1, and the reference value BASE is updated with the same value. Further, at the time t1, because the electrostatic input apparatus 100 is in the temporary activation mode, the control unit 140 does not determine the presence or absence of a contact operation, and the touch state is off.

Note that, as at time t1, there is no change from the value of the reference value BASE before updating, and instead of updating the reference value BASE with the same value, the following may be performed. That is, when the control unit 140 compares the reference value BASE before updating with the digital output value AD acquired for updating, and the reference value BASE before updating is equal to the digital output value AD acquired for updating, the reference value BASE before updating may be continuously used as the reference value BASE without updating the reference value BASE before updating with the acquired digital output value AD. In this manner, the concept of updating the reference value BASE includes comparing the reference value BASE before updating with the digital output value AD acquired for updating, and continuously using the reference value BASE before updating as the reference value BASE.

At time t2, the digital output value AD increases. This is because, for example, the operator touches the operation surface 131 with his/her fingertip immediately before turning on the ignition, the power switch, or the like of the vehicle.

At time t3, the control unit 140 switches from the standby mode to the regular mode. This is because the ignition, the power switch, or the like of the vehicle in which the electrostatic input apparatus 100 is mounted, is turned on. When the control unit 140 switches to the regular mode at time t3, the control unit performs repeated scanning at a predetermined cycle instead of an intermittent operation. Therefore, after time t3, the scan level is continuously at the execution level.

Immediately after switching to the regular mode, the control unit 140 does not update the reference value BASE, but uses a difference value ΔAD obtained by subtracting the reference value BASE last updated in the temporary activation mode (the reference value BASE updated at time t1) from the digital output value AD first acquired in the regular mode (the digital output value AD acquired at time t3) to determine the presence or absence of the contact operation.

As a result, at time t3, the difference value ΔAD becomes greater than or equal to the threshold value for determining the contact operation, and the control unit 140 determines that the contact operation has occurred and turns on the touch state. As described above, the reference value BASE is acquired by intermittent operation in the low power consumption mode, and when switching to the regular mode, the difference value ΔAD is calculated by using the reference value BASE last updated in the low power consumption mode to determine the presence or absence of the contact operation. Thus, when returning to the regular mode, the position of the operation input can be quickly determined. That is, when returning to the regular mode, there is no need for processing to update the reference value BASE, and the position of the operation input can be quickly determined.

### Operation of FIG. 3B

In FIG. 3B, at time t1, the control unit 140 acquires the digital output value AD by scanning with intermittent operation and updates the reference value BASE. The acquired digital output value AD is indicated by a black circle (●). Because the digital output value AD is very small, the reference value BASE is also very small. Further, the control unit 140 calculates the difference value ΔAD, but because both the digital output value AD and the reference value BASE are small values, the difference value ΔAD does not change. Therefore, there is no change from the value of the reference value BASE before the time t1, and the reference value BASE is updated with the same value. Further, at the time t1, because the electrostatic input apparatus 100 is in the temporary activation mode, the control unit 140 does not determine the presence or absence of a contact operation, and the touch state is off. Up to this point, the operation is the same as that illustrated in FIG. 3A.

At a time point after the time t1 and before the time t2, the digital output value AD increases. This increase in the digital output value AD is caused, for example, by the operator's hand or another object approaching the operation surface 131.

At time t2, the control unit 140 acquires the digital output value AD by scanning in an intermittent operation, and acquires a new reference value BASE. In the operation of FIG. 3B, the control unit 140 calculates the absolute value of the difference value (change in the reference value BASE) between the previously updated reference value BASE and the currently acquired digital output value AD, and determines whether or not the absolute value of the difference value is greater than or equal to the threshold value by using a threshold value for not updating the value of the reference value BASE when there is a rapid change in the reference value BASE. At time t2 in the operation of FIG. 3B, because the absolute value of the difference value (change in the reference value BASE) between the previously measured reference value BASE and the currently acquired digital output value AD exceeds the threshold value, the control unit 140 does not update the value of the reference value BASE. Therefore, there is no change from the value of the reference value BASE before time t1, and the reference value BASE is updated with the same value. Further, because the digital output value AD has increased, the difference value ΔAD calculated by the control unit 140 increases at time t2.

At time t3, the control unit 140 switches from the standby mode to the regular mode and acquires the digital output value AD. This is because the ignition and power switch of the vehicle in which the electrostatic input apparatus 100 is mounted are turned on.

When the mode switches to the regular mode at time t3, the control unit 140 performs repeated scanning at a predetermined cycle instead of intermittent operation. Therefore, after time t3, the scanning level is continuously at the execution level.

The control unit 140 does not update the reference value BASE immediately after switching to the regular mode, but uses a difference value ΔAD obtained by subtracting the reference value BASE last updated in the temporary activation mode (the reference value BASE updated at time t2) from the digital output value AD first acquired in the regular mode (the digital output value AD acquired at time t3) to determine the presence or absence of a contact operation. Therefore, the position of the operation input can be quickly determined.

### Operation of FIG. 3C

In FIG. 3C, at time t1, the control unit 140 acquires the digital output value AD by scanning in an intermittent operation and updates the reference value BASE. That is, the mode is intermittently switched to the temporary activation mode during the standby mode to acquire the digital output value AD, update the reference value BASE, and calculate the difference value ΔAD. The acquired digital output value AD is indicated by a black circle (●). In FIG. 3C, because the digital output value AD has a gradual increasing tendency, the difference value ΔAD calculated by the control unit 140 becomes slightly larger. Then, the reference value BASE is updated to a value increased by the difference value ΔAD. Further, at time t1, because the electrostatic input apparatus 100 is in the temporary activation mode, the control unit 140 does not determine the presence or absence of a contact operation, and the touch state is off.

At time t2, the control unit 140 acquires the digital output value AD by scanning in the intermittent operation, and updates the reference value BASE. Because the digital output value AD is gradually increased from time t1, it is slightly larger than the reference value BASE updated at time t1. As an example, the difference value ΔAD between the digital output value AD acquired at time t2 and the reference value BASE updated at time t1 becomes a value slightly larger than the difference value ΔAD obtained at time t1. The reference value BASE is updated to a value increased by the difference value ΔAD from the reference value BASE updated at time t1. Further, at time t2, because the electrostatic input apparatus 100 is in the temporary activation mode, the control unit 140 does not determine the presence or absence of a contact operation, and the touch state is off. Because the digital output value AD gradually increases from the time t1, the control unit 140 sets a predetermined time interval for performing the intermittent operation to be longer so as not to overlook a gradual change (drift) in the digital output value AD.

At the time t3, the control unit 140 acquires the digital output value AD by scanning in the intermittent operation and updates the reference value BASE. Because the control unit 140 sets a predetermined time interval for performing the intermittent operation to be longer at the time t2, the time interval between the times t2 and t3 is longer than the time interval between the times t1 and t2.

Because the digital output value AD slightly increases from the value at the time t2, the value of the reference value BASE also slightly increases from the value at the time t2. The difference value ΔAD between the digital output value AD acquired at the time t3 and the reference value BASE updated at the time t2 becomes a value slightly increased from the difference value ΔAD obtained at the time t2. The reference value BASE is updated to a value increased by the difference value ΔAD from the reference value BASE updated at the time t2. Further, at the time t3, because the electrostatic input apparatus 100 is in the temporary activation mode, the control unit 140 does not determine the presence or absence of a contact operation, and the touch state is off.

At time t4, the digital output value AD increases. This is caused by the fact that the operator touched the operation surface 131 with his/her fingertip just before turning on the ignition, the power switch, or the like of the vehicle.

At time t4, the control unit 140 switches from the standby mode to the regular mode. This is because the ignition, the power switch, or the like of the vehicle in which the electrostatic input apparatus 100 is mounted are turned on. When the mode switches to the regular mode at time t4, the control unit 140 performs repeated scanning at a predetermined cycle instead of an intermittent operation. Therefore, after time t4, the scan level is continuously at the execution level.

At time t4, the control unit 140 acquires the digital output value AD. When switching to the regular mode, the control unit 140 does not update the reference value BASE, but uses a difference value ΔAD obtained by subtracting the reference value BASE last updated in the temporary activation mode (the reference value BASE updated at time t3) from the digital output value AD first acquired in the regular mode (the digital output value AD acquired at time t4) to determine the presence or absence of a contact operation.

As a result, at time t4, the difference value ΔAD becomes greater than or equal to the threshold value for determining the contact operation, and the control unit 140 determines that the contact operation has occurred, and the touch state is turned on. In this manner, the reference value BASE is acquired by the intermittent operation in the low power consumption mode, and when the mode is switched to the regular mode, the difference value ΔAD is calculated by using the reference value BASE that was last updated in the low power consumption mode, and the presence or absence of the contact operation is determined. Thus, when the mode returns to the regular mode, the position of the operation input can be quickly determined. That is, when the mode returns to the regular mode, the processing for updating the reference value BASE is not required, and the position of the operation input can be quickly determined.

Note that FIG. 3C described a configuration in which the control unit 140 sets a predetermined time interval for performing the intermittent operation longer at time t2, so that the time interval between times t2 and t3 becomes longer than the time interval between times t1 and t2. However, the control unit 140 may detect a gradual increasing trend of the digital output value AD at time t1, and make the time interval between times t1 and t2 shorter than the time interval between times t2 and t3.

### Operation of FIG. 3D (operation for comparison)

FIG. 3D is a diagram illustrating an example of the operation of the electrostatic input apparatus for comparison. Because the electrostatic input apparatus for comparison does not have a temporary activation mode like the electrostatic input apparatus 100, it does not update the reference value BASE in the low power consumption mode, but updates the reference value BASE after switching from the standby mode to the regular mode.

In FIG. 3D, the electrostatic input apparatus for comparison is in the standby mode before time t1. The electrostatic input apparatus for comparison does not update the reference value BASE in the standby mode.

At time t1, the digital output value AD increases. This is caused by the fact that the operator touches the operation surface 131 with his/her fingertip just before turning on the ignition or the power switch of the vehicle.

At time t2, the electrostatic input apparatus for comparison switches from the standby mode to the regular mode and acquires the digital output value AD. The mode is switched to the regular mode because the ignition, the power switch, or the like of the vehicle in which the electrostatic input apparatus for comparison is mounted is turned on.

When the mode is switched to the regular mode at time t2, the electrostatic input apparatus for comparison updates the reference value BASE. However, because the digital output value AD is higher from time t1, which is before time t2, the reference value BASE is larger. As a result, because the difference value ΔAD between the digital output value AD acquired at time t2 and the reference value BASE updated at time t2 is small and less than the threshold value for determining a contact operation, it is determined that there is no contact operation, and the touch state remains off.

As described above, because the electrostatic input apparatus for comparison does not update the reference value BASE in the standby mode but updates the reference value BASE after switching from the standby mode to the regular mode, determination of the presence or absence of a contact operation is delayed by the amount of updating the reference value BASE. Further, as illustrated in FIG. 3D, because the reference value BASE is updated after switching to the regular mode and increasing the digital output value AD, the value of the reference value BASE becomes larger, and the difference value ΔAD cannot be appropriately acquired, and the presence or absence of a contact operation cannot be accurately determined.

### Adjustment of a predetermined time interval for intermittent operation

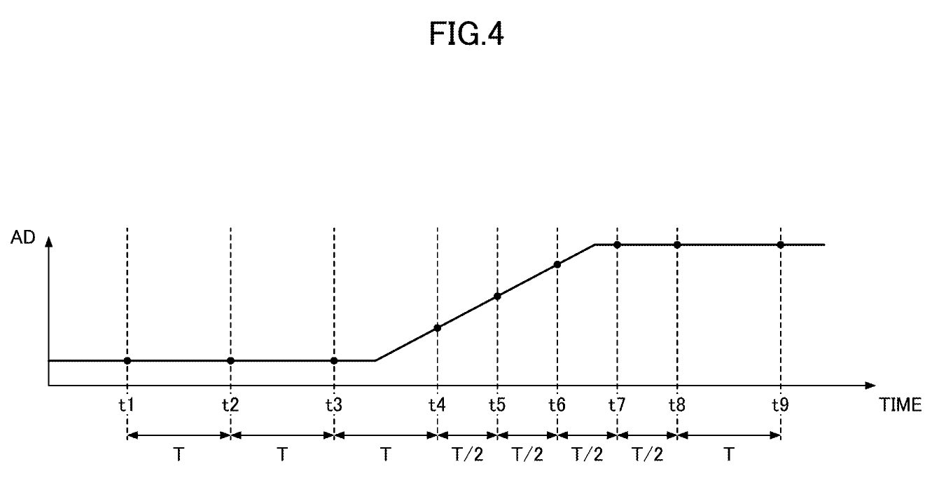

FIG. 4 is a diagram for explaining an example of adjustment of a predetermined time interval for performing the intermittent operation. In FIG. 4, the horizontal axis represents time, and the vertical axis represents a digital output value AD. In FIG. 4, the timing for updating the reference value BASE in the temporary activation mode is indicated by black circles (●) at times t1 to t9. Here, when there is no influence of disturbance, the control unit 140 sets a predetermined time interval for performing the intermittent operation to a standard time interval T as an example.

Here, the disturbance is a change in the environment around the electrostatic input apparatus 100, for example, a change in temperature or humidity. As an example, when the temperature rises, the capacitance tends to increase due to expansion of a resin component or the like around the electrostatic input apparatus 100. When the humidity changes, the capacitance tends to fluctuate due to a change in the dielectric constant of air or the like. When the capacitance between the sensor electrode 121 and the fingertip changes, the digital output value AD changes. For example, in a case where the electrostatic input apparatus 100 is mounted in a vehicle, if the door is opened while the temperature and humidity of the interior of the vehicle are being adjusted by an air conditioner, the outside air is introduced into the interior of the vehicle, which causes an influence of disturbance on the electrostatic input apparatus 100.

When the influence of the disturbance of the electrostatic input apparatus 100 occurs, the predetermined time interval for performing the intermittent operation for updating the reference value BASE may be lengthened or shortened. Whether the predetermined time interval is lengthened or shortened may be appropriately set according to the characteristics of the change in the digital output value AD caused by the disturbance. By adjusting the predetermined time interval for performing the intermittent operation, it becomes easier to follow the change in the digital output value AD, and it becomes possible to determine the presence or absence of the contact operation with higher accuracy.

FIG. 4 describes, as an example, a case where the digital output value AD changes due to the disturbance. Whether or not the change in the digital output value AD is caused by the influence of the disturbance may be determined, for example, by determining whether or not the rate of change in the digital output value AD with time is very large as compared with the case where the operation input is performed. Whether or not the rate of change in the digital output value AD with time is very large as compared with the case where the operation input is performed may be determined, for example, by using a threshold value for the absolute value of the rate of change in the digital output value AD with time.

Because the digital output value AD is constant at times t1 to t3, the control unit 140 switches from the standby mode to the temporary activation mode at every time interval T to update the reference value BASE.

After time t3, the digital output value AD increases. At time t4, when a time interval T has elapsed from time t3, the control unit 140 switches from the standby mode to the temporary activation mode and updates the reference value BASE.

At time t4, the control unit 140 determines that the absolute value of the rate of change in the digital output value AD with time is very large and is greater than or equal to the threshold value. At time t4, the control unit 140 shortens the time interval to T/2, and at times t5, t6, t7, and t8, switches from the standby mode to the temporary activation mode and updates the reference value BASE. The time intervals at times t5 to t6, t6 to t7, and t7 to t8 are all T/2.

After time t6, the digital output value AD becomes constant. At time t8, the control unit 140 determines that the absolute value of the rate of change in the digital output value AD with time is small and less than the threshold value. At time t8, the control unit 140 changes the time interval back to T, and at time t9, at which time T has elapsed from time t8, switches from the standby mode to the temporary activation mode to update the reference value BASE. In this manner, the time interval for switching from the standby mode to the temporary activation mode may be shortened according to the influence of the disturbance.

Here, a configuration in which the time interval for switching from the standby mode to the temporary activation mode is shorter than the standard time interval T according to the influence of the disturbance has been described with reference to FIG. 4. However, the time interval for switching from the standby mode to the temporary activation mode may be longer than the standard time interval T according to the influence of the disturbance.

### Flowchart

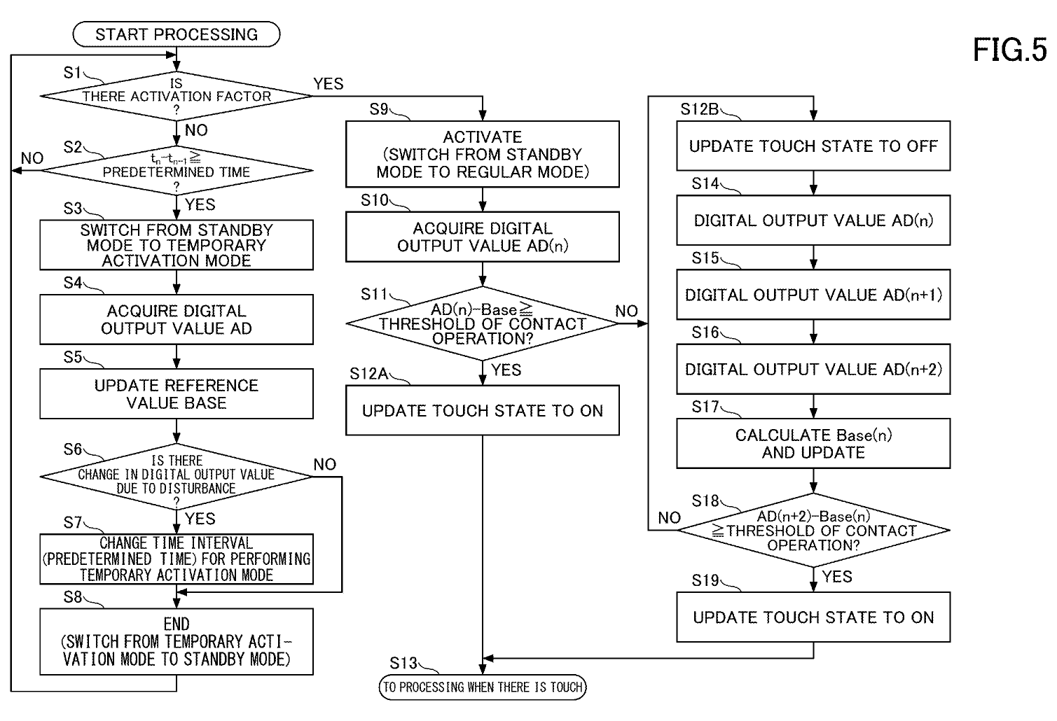

FIG. 5 is a flowchart illustrating an example of a process executed by the control unit 140 of the electrostatic input apparatus 100. When the control unit 140 starts the process, the mode of the electrostatic input apparatus 100 is the standby mode. In the flowchart of FIG. 5, as an example, a process that does not directly transition from the temporary activation mode to the regular mode but returns from the temporary activation mode to the standby mode and then transitions to the regular mode will be described.

When the process is started, the control unit 140 determines whether or not there is an activation factor (step S1). Activation means switching from the standby mode to the regular mode. As an example, the activation factor is that the ignition, the power switch, or the like of the vehicle in which the electrostatic input apparatus 100 is mounted is turned on. As an example, when the ignition, the power switch, or the like of the vehicle are turned on, the ECU (Electronic Control Unit) which controls the ignition, the power switch, or the like of the vehicle outputs to the control unit 140 an ON signal indicating that they are turned on. When the ignition, the power switch, or the like are off, the ECU which controls the ignition, the power switch, or the like of the vehicle does not output an ON signal.

When the control unit 140 determines that there is no activation factor (S1: NO), it determines whether the elapsed time tₙ-tₙ₋₁ counted by the timer is greater than or equal to a predetermined time (step S2). The predetermined time is a time corresponding to the predetermined time interval described with reference to FIG. 4. When the control unit 140 does not receive an ON signal, it determines that there is no activation factor (S1: NO). The control unit 140 has a built-in timer and determines whether or not the elapsed time obtained by subtracting the count value tₙ at the end of the current count from the count value tₙ₋₁ at the end of the previous count is greater than or equal to a predetermined time. If the control unit 140 determines at step S2 that the elapsed time tₙ-tₙ₋₁ is not greater than or equal to a predetermined time (S2: NO), the flow returns to step S1.

If the control unit 140 determines at step S2 that the elapsed time tₙ-tₙ₋₁ is greater than or equal to a predetermined time (S2: YES), the mode of the electrostatic input apparatus 100 is switched from the standby mode to the temporary activation mode (step S3).

The control unit 140 acquires the digital output value AD (step S4).

The control unit 140 updates the reference value BASE based on the digital output value AD acquired at step S4 (step S5).

The control unit 140 determines whether or not the digital output value AD changes due to the disturbance (step S6). For example, the control unit 140 may determine whether or not the digital output value AD changes due to the disturbance by determining whether or not the absolute value of the rate of change in the digital output value AD over time is greater than or equal to the threshold value.

When it is determined that the digital output value AD changes due to the disturbance (S6: YES), the control unit 140 changes the time interval (predetermined time) for performing the temporary activation mode (step S7). When the control unit 140 finishes the processing of step S7, the flow proceeds to step S8.

If the control unit 140 determines in step S6 that there is no change in the digital output value AD due to the disturbance (S6: NO), the flow proceeds to step S8.

The control unit 140 ends the series of processing and switches the mode of the electrostatic input apparatus 100 from the temporary activation mode to the standby mode (step S8).

If it is determined in step S1 that there is an activation factor (S1: YES), the control unit 140 activates the electrostatic input apparatus 100 and switches the mode of the electrostatic input apparatus 100 from the standby mode to the regular mode (step S9). The control unit 140 switches the mode of the electrostatic input apparatus 100 to the regular mode when it receives an ON signal indicating that the ignition, the power switch, and the like are turned on from the ECU controlling the ignition, the power switch, and the like of the vehicle.

The control unit 140 acquires a digital output value AD(n) (step S10).

The control unit 140 determines whether the difference value ΔAD obtained by subtracting the reference value BASE that was last updated in the temporary activation mode from the digital output value AD(n) acquired in step S10 is greater than or equal to the threshold value of the contact operation (step S11).

When the control unit 140 determines that the difference value ΔAD is greater than or equal to the threshold value of the contact operation (step S11: YES), the control unit updates the touch state to ON (step S12A).

The control unit 140 executes a process when a contact operation is performed (step S13). The process when a contact operation is performed is, for example, a process of notifying a device including the electrostatic input apparatus 100 as an input unit that a contact operation is performed and providing the coordinates of the contact operation.

If it is determined in step S11 that the difference value ΔAD is not greater than or equal to the threshold value of the contact operation (step S11: NO), the control unit 140 updates the touch state to OFF (step S12B).

The control unit 140 acquires the digital output value AD(n) (step S14).

The control unit 140 acquires the digital output value AD(n+1) (step S15).

The control unit 140 acquires the digital output value AD(n+2) (step S16).

The control unit 140 updates the reference value BASE by the value calculated by using the digital output values AD(n), AS(n+1), and AD(n+2) acquired in steps S14, S15, and S16 (step S17). In the processing of step S17, there may be a case where there is no change from the value of the reference value BASE before updating and the reference value BASE is updated with the same value.

For example, the control unit 140 acquires, as the reference value BASE, a value calculated by performing a filter processing on the digital output values AD(n), AS(n+1), and AD(n+2) acquired in steps S14, S15, and S16, and updates the value. The filter processing may be a variety of calculation processes, but one example is a process of calculating a weighted average of the digital output values AD(n), AS(n+1), and AD(n+2).

The control unit 140 determines whether the difference value ΔAD obtained by subtracting the reference value BASE updated in step S17 from the latest digital output value AD(n+2), is greater than or equal to the threshold value of the contact operation (step S18).

When the control unit 140 determines that the difference value ΔAD is greater than or equal to the threshold value of the contact operation (step S18: YES), the control unit updates the touch state to ON (step S19). When the processing of step S19 is completed, the control unit 140 advances the flow to step S13.

On the other hand, when the control unit 140 determines that the difference value ΔAD is not greater than or equal to the threshold value of the contact operation (step S18: NO), the flow returns to step S12B.

Thus, a series of processes is completed.

### Effect

The electrostatic input apparatus 100 includes a sensor electrode 121 for input detection, and a control unit 140 which performs switching control between the regular mode and the low power consumption mode and determination of the presence/absence of an operation input based on the difference value obtained by subtracting the reference value from the digital output value AD of the sensor electrode 121, wherein the control unit 140 updates the reference value based on the digital output value AD in the low power consumption mode by intermittent operation, and determines the presence/absence of the operation input for the first time after switching from the low power consumption mode to the regular mode by using the digital output value AD first acquired in the determination of the presence/absence of the operation input for the first time and the reference value last updated in the low power consumption mode. Thus, when determining the presence/absence of the operation input for the first time after switching from the low power consumption mode to the regular mode, it is not necessary to update the reference value, and the position of the operation input can be quickly determined by using the reference value last updated in the low power consumption mode.

Therefore, the electrostatic input apparatus 100, which can quickly determine the position of the operation input when returning from the low power consumption mode to the regular mode, can be provided.

In the first determination of the presence or absence of the operation input after switching from the low power consumption mode to the regular mode, the control unit 140 may determine the presence or absence of the operation input by comparing a difference value obtained by subtracting the reference value last updated in the low power consumption mode from the digital output value AD first acquired in the first determination of the presence or absence of the operation input, with a predetermined threshold value. By comparing the difference value obtained by subtracting the reference value from the digital output value AD with the predetermined threshold value, the influence of noise can be reduced, and the presence or absence of the contact operation can be determined with high accuracy.

The control unit 140 may determine the presence or absence of the operation input by using a plurality of predetermined thresholds corresponding to the distance between the sensor electrode 121 and the object for which the operation input is performed. By using a plurality of predetermined thresholds, the operation of the operator can be divided into a plurality of stages, and the presence or absence of each operation can be determined. For example, in order to determine the distance between the operation surface 131 and the fingertip in stages, the plurality of predetermined thresholds can be set so as to determine the operation of any 2 or more of the 4 types of operation inputs: proximity operation, selection operation, determination operation, and contact operation.

The control unit 140 may update the reference value BASE based on the digital output value AD when the difference value ΔAD is less than the predetermined threshold and it is determined that there is no operation input. When the difference value ΔAD is less than the predetermined threshold and it is determined that there is no operation input, it is a case where the change of the digital output value AD is small and the changes is slow. As described above, by updating the reference value BASE when the digital output value AD changes slowly, the reference value BASE can be stably updated avoiding a case where the digital output value changes rapidly. Further, by stably updating the reference value BASE in this manner, the operation of the electrostatic input apparatus 100 can be stabilized.

Further, the control unit 140 may change the update interval for updating the reference value in the intermittent operation according to the degree of change of the digital output value AD. For example, it is possible to update the reference value at an appropriate update interval following a change in the digital output value AD due to a change in the environment around the electrostatic input apparatus 100 (a change in disturbance).

An electrostatic input apparatus capable of quickly determining the position of an operation input when returning from a low power consumption mode to a regular mode, can be provided.

Although the electrostatic input apparatus according to an exemplary embodiment of the present disclosure has been described above, the present disclosure is not limited to the embodiment specifically disclosed, and various modifications and changes are possible without departing from the scope of the claims.

WHAT IS CLAIMED IS:

1. An electrostatic input apparatus comprising:
a sensor electrode configured to perform input detection;
a processor; and
a memory that includes instructions, which when executed, cause the processor to execute:
performing switching control between a regular mode and a low power consumption mode, and determining presence or absence of an operation input based on a difference value obtained by subtracting a reference value from an output value of the sensor electrode;
updating the reference value based on the output value in an intermittent operation in the low power consumption mode; and
in a first determination of first determining the presence or absence of the operation input after switching from the low power consumption mode to the regular mode, determining the presence or absence by using the output value first acquired in the first determination of the presence or absence of the operation input and the reference value last updated in the low power consumption mode.

2. The electrostatic input apparatus according to claim 1, wherein the instructions, which when executed, cause the processor to execute, in the first determination of the presence or absence of the operation input after switching from the low power consumption mode to the regular mode, determining the presence or absence of the operation input by comparing, to a predetermined threshold value, the difference value obtained by subtracting the reference value last updated in the low power consumption mode from the output value first acquired in the first determination of the presence or absence of the operation input.

3. The electrostatic input apparatus according to claim 2, wherein the instructions, which when executed, cause the processor to execute determining the presence or absence of the operation input by using a plurality of the predetermined threshold values corresponding to a distance between the sensor electrode and an object to which the operation input is to be made.

4. The electrostatic input apparatus according to claim 2, wherein the instructions, which when executed, cause the processor to execute updating the reference value based on the output value when the difference value is less than the predetermined threshold value and determining that there is no operation input.

5. The electrostatic input apparatus according to claim 1, wherein the instructions, which when executed, cause the processor to execute changing an update interval for updating the reference value in the intermittent operation according to a degree of change of the output value.

6. The electrostatic input apparatus according to claim 1, wherein the instructions, which when executed, cause the processor to execute, in updating the reference value based on the output value in the intermittent operation in the low power consumption mode, refraining from updating the reference value by using the output value acquired in the intermittent operation, when an absolute value of a difference between the reference value before updating and the output value acquired in the intermittent operation is greater than or equal to a predetermined value.
